(19) United States
(12) Patent Application Publication
(10) Pub. No.: US 2007/0008695 A1
(43) Pub. Date: Jan. 11, 2007

(54) REMOVABLE HARD DISC LOADING DEVICE

(76) Inventor: Peng-Hui Chou, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/419,755

(22) Filed: May 22, 2006

(30) Foreign Application Priority Data
Jul. 11, 2005 (TW) 094211749

(51) Int. Cl. G06F 1/16

(52) U.S. Cl. 361/685

(57) ABSTRACT

A removable hard disk loading device includes a hard disc tray including a first loading place for placing a hard disk of a first size, and an accessory capable of being placed in the first containing place, wherein the accessory includes a second loading place for placing a hard disk of a second size.

### BACKGROUND OF THE INVENTION

1. Field of the Invention

The invention relates to a removable hard disk loading device, and more particularly, to a removable hard disk loading device capable of loading a 3.5-inch hard disk and utilizing an accessory to load a 2.5-inch hard disk.

2. Description of the Prior Art

Computer systems have become an essential part of people's life. Nowadays, almost all work is performed utilizing computers. To support this there is a huge variety of storage media available in the market. For example, soft disks or CD disks are firstly utilized for storing data. The disadvantage of these disks is they are limited in capacity and the number of times they can be overwritten. Furthermore, because of the significantly large population of video data or multimedia data, the amount of a file data is larger than the basic capacity of a normal soft disk or a CD disk. Hard disks are still the most widely utilized storage medium due to their characteristics of large capacity and re-writing ability.

There are two types of hard disks, 3.5-inch hard disks and 2.5-inch hard disks, available on the market. Generally speaking, the 3.5-inch hard disk is installed in a large computer system (such as a personal computer, or computer server), and the 2.5-inch hard disk is installed in a computer system that is more strictly limited in space (for example, a laptop). Regardless of which disk is used, they are almost always installed inside the housing of the computer system. In other words, it is not easy for the user to load or unload the hard disk inside the housing. Furthermore, because the loading/unloading operation is not easy, the users rarely carry the hard disk as a removable storage medium. This may result in the data exchange of the hard disk being reduced.

To solve this problem, a removable hard disk loading device was developed. The most well known removable hard disk loading device is an HDD tray. The hard disk is no longer placed inside the housing through the above-mentioned complicated operations. Instead, the hard disk can be connected to the computer system (such as the motherboard) in a simple way (for example, the hard disk is plugged into the computer). Therefore, the trouble of connecting the hard disk can be avoided.

Please refer to FIG. 1, which is a diagram of an HDD tray 100 according to the prior art. As shown in FIG. 1, the HDD tray 100 comprises a loading space 1 10 for placing the hard disk. That is, the hard disk is loaded inside the loading space 110. In addition, the HDD tray 100 further comprises a handle 1 20 enabling users to easily pull out/install the whole HDD tray 100.

Please refer to FIG. 2, which is a diagram of an HDD tray 100 installed inside a computer server 200. Generally speaking, because the computer server 200 has to provide a lot of services (such as the storage space on the internet), the computer server 200 needs many hard disks. As shown in FIG. 2, the computer server 200 can comprise a plurality of plugs for placing a plurality of HDD trays 100. As mentioned previously, when the HDD tray 100 is placed inside the computer server 200, only the handle 1 20 is shown outside the computer server 200. Therefore, the user can pull out the HDD tray 100 by utilizing the handle. On the other hand, when the hard disk is placed in the HDD tray 100, the connecting port and the handle 120 are respectively located on different sides of the HDD tray 100. Therefore, the connecting port is placed inside the computer server 200 such that the connecting port can be connected to the computer server through a well-known IDE bus or SATA bus.

As mentioned previously, both 3.5-inch and 2.5-inch hard disks are available on the market. Most HDD trays 100, however, are manufactured according to a specific size of a hard disk. That is, a 3.5-inch hard disk has its own corresponding 3.5-inch HDD tray, and a 2.5-inch HDD tray hard disk has its own corresponding 2.5-inch HDD tray. They can only be utilized with the corresponding size disk. From an economic point of view, if the user owns a 2.5-inch hard disk and a 3.5-inch HDD tray, it is not practical for the user to buy a 3.5-inch hard disk or a 2.5-inch HDD tray as well. Furthermore, many of the computer servers 200 only have spaces corresponding to the 3.5-inch hard disk. That is, even if the user has a 2.5-inch hard disk and a 2.5-inch HDD tray, they cannot easily be utilized in the computer server 200. Furthermore, if the 2.5-inch and 3.5-inch HDD trays are simultaneously loaded in the computer server 200, the appearance lacks consistence. Therefore, considering the aesthetics, it is not a good choice to simultaneously utilize the 2.5-inch and 3.5-inch HDD trays.

### SUMMARY OF THE INVENTION

It is therefore one of the primary objectives of the claimed invention to provide a removable hard disk loading device to solve the above-mentioned problem.

According to an exemplary embodiment of the claimed invention, a removable hard disk loading device is disclosed. The removable hard disk loading device comprises: a hard disk drive tray (HDD tray) comprising a first loading space for loading a first hard disk of a first size; and an accessory, capable of being placed in the first loading space, comprising a second loading space for loading a second hard disk of a second size.

The embodiment of the present invention HDD tray comprises a U-shaped accessory. Therefore, the embodiment of the present invention can support hard disks of different sizes. This means the user does not need to buy additional hard disks or HDD trays. Furthermore, because the embodiment of the present invention HDD tray can support hard disks of different sizes (for example, the 3.5-inch hard disk and 2.5-inch hard disk), the computer server does not need to have spaces with different sizes. In other words, the computer server only needs to support the present invention 3.5-inch HDD tray. Therefore, this ensures the consistency of the appearance, and makes the computer server more aesthetically pleasing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an HDD tray according to the prior art.

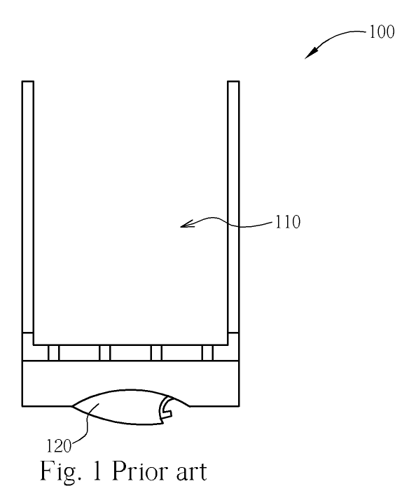

FIG. 2 is a diagram of an HDD tray installed inside a computer server according to the prior art.

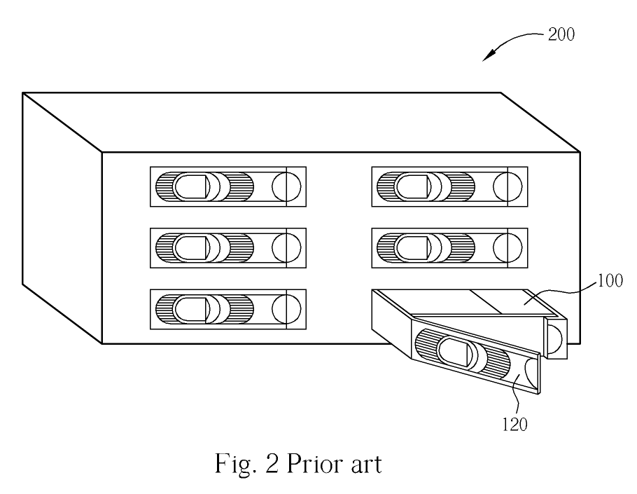

FIG. 3 is a diagram of a removable hard disk loading device according to the present invention.

### DETAILED DESCRIPTION

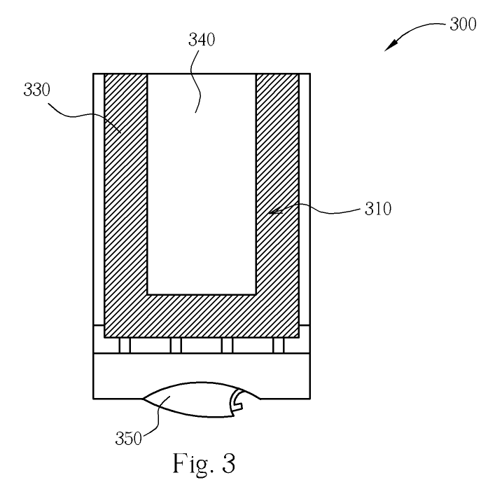

Please refer to FIG. 3, which is a diagram of a removable hard disk loading device 300 according to the embodiment of the present invention. In this embodiment, the removable hard disk loading device 300 comprises a 3.5-inch HDD tray 310. As mentioned previously, the HDD tray 310 comprises a loading space 320 for placing a 3.5-inch hard disk. Please note that a U-shaped accessory 330 is placed in the loading space 320 of the HDD tray 310, wherein the U-shaped accessory 330 also comprises a loading space 340 for placing a 2.5-inch hard disk. Similar to the above-mentioned HDD tray 100, the HDD tray 310 can also comprise a handle 350 for the user to easily pull out/install the whole removable hard disk loading device 300.

The 2.5-inch hard disk can be placed in the loading space 340, and because the size of the U-shaped accessory 330 corresponds to a 3.5-inch space, the U-shaped accessory 330 can be embedded inside the HDD tray 310, which originally supported the 3.5-inch hard disk. In addition, because the loading space 340 of the U-shaped accessory 330 corresponds to 2.5-inch hard disk, the 2.5-inch hard disk can be placed inside the U-shaped accessory 330. In other words, the 2.5-inch hard disk can be placed inside the HDD tray 310 through utilizing the U-shaped accessory 330.

Please note that the U-shaped accessory 330 is a removable accessory, and therefore if removed, the HDD tray 310 can load the 3.5-inch hard disk. However, when the U-shaped accessory 330 is installed in the HDD tray 310, the HDD tray 310 can support 2.5-inch hard disks. That is, the removable hard disk loading device 300 can support both 3.5-inch and 2.5-inch hard disks.

The embodiment of the present invention HDD tray 310 has a similar structure to the prior art HDD tray 100. For example, the HDD tray 310 only increases a U-shaped accessory 330. Therefore, the method and structure for installing the removable hard disk loading device 300 are similar to the prior art HDD tray 100. In other words, when the removable hard disk loading device 300 is installed inside the computer server, only the handle 350 is shown outside such that the user can utilize the handle 350 to pull out the removable hard disk loading device 300. On the other hand, when the hard disk is placed in the HDD tray 310 (or the U-shaped accessory 330), the connecting port and the handle 350 are respectively located on different sides of the HDD tray 310. Therefore, the connecting port is placed inside the computer server such that the connecting port can be connected to the computer server through a well-known IDE bus or SATA bus. Those skilled in the art will understand corresponding installation methods and the related steps, and detailed illustration is therefore omitted.

Please note that the material of the present invention U-shaped accessory 330 is not limited. In other words, the U-shaped accessory 330 can be made of plastics, when cost is a factor, or can be made of metal to utilize the heat radiation ability. These embodiments also obey the spirit of the present invention.

Please note that in the above disclosure, the present invention removable hard disk loading device 300 is utilized in a computer server. In the actual implementation, however, the field that the present invention is utilized in is not limited. In other words, the removable hard disk loading device 300 can be utilized in a variety of computer systems. This also obeys the spirit of the present invention.

In contrast to the prior art, the HDD tray comprises a U-shaped accessory. Therefore, the embodiment of the present invention can support hard disks of different sizes, negating the need for the user to buy additional hard disks or HDD trays. Furthermore, because the HDD tray can support hard disks of different sizes (for example, the 3.5-inch hard disk and 2.5-inch hard disk), the computer server does not need to have spaces of different sizes. In other words, the computer server only needs to support the present invention 3.5-inch HDD tray. Therefore, this ensures the consistency of the computer's appearance, and makes the computer server more aesthetically pleasing.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A removable hard disk loading device comprising:
a hard disk tray (HDD tray) comprising a first loading space for loading a first hard disk of a first size; and
an accessory, capable of being placed in the first loading space, comprising a second loading space for loading a second hard disk of a second size.

2. The removable hard disk loading device of claim 1, wherein the accessory is a U-shaped structure.

3. The removable hard disk loading device of claim 1, wherein the first hard disk of the first size is 3.5-inches hard disk.

4. The removable hard disk loading device of claim 1, wherein the second hard disk of the second size is 2.5-inches.
